(19) United States
(12) Patent Application Publication
(10) Pub. No.: US 2026/0116091 A1
(43) Pub. Date: Apr. 30, 2026

(54) INKJET INK PRINTING DEVICE AND METHOD FOR PRODUCING PRINTED MATTER

(71) Applicant: RISO KAGAKU CORPORATION, Tokyo (JP)

(72) Inventors: Hirotaka YAMAMOTO, Tokyo (JP); Ami NAKATA, Tokyo (JP)

(21) Appl. No.: 19/372,997

(22) Filed: Oct. 29, 2025

(30) Foreign Application Priority Data
Oct. 30, 2024 (JP) 2024-190713
Sep. 10, 2025 (JP) 2025-150415

(51) Int. Cl. B41J 11/00; B41J 2/21; B41J 3/407; B41M 7/00

(52) U.S. Cl. CPC B41J 11/0022; B41J 2/2132; B41J 3/407; B41J 11/0024; B41M 7/009

(57) ABSTRACT

Disclosed is an inkjet printing device comprising an inkjet head that jets ink to attach the ink to a non-absorbent or low-absorbent printing medium, a heating unit that heats the printing medium for drying the ink attached to the printing medium, and an air sending unit that blows air onto the printing medium for drying the ink attached to the printing medium, wherein the ink contains a predetermined amount of water and an organic solvent S including a predetermined organic solvent A, the heating unit heats the printing medium so that a surface temperature of the printing media is 40 to 43° C., and the air sending unit blows air at an air velocity of 0.2 to 1.5 m/sec onto the printing medium.

### CROSS REFERENCE TO RELATED APPLICATIONS

This application is based upon and claims the benefit of priority from the Japanese Patent Application No. 2024-190713, filed on Oct. 30, 2024, and the benefit of priority from the prior Japanese Patent Application No. 2025-150415, filed on Sep. 10, 2025, the entire contents of which are incorporated by reference herein.

### BACKGROUND OF THE INVENTION

### Field of the Invention

The present disclosure relates to an inkjet printing device and a method for producing printed matter.

### Description of the Related Art

In the case of printing on a non-absorbent or low-absorbent printing medium with an inkjet printing device, ink containing a highly volatile organic solvent is commonly used for suppressing occurrence of bleeding in an image, which deteriorates image quality.

In inkjet printing devices, a printing medium to which ink has been jetted is dried by heating with a heater or the like for suppressing the deterioration of image quality due to bleeding of the image and achieving high productivity (Japanese Patent Nos. 7428043 and 4429923).

### SUMMARY OF THE INVENTION

According to an aspect of the present disclosure, there is provided an inkjet printing device comprising an inkjet head that jets ink to attach the ink to a non-absorbent or low-absorbent printing medium, a heating unit that heats the printing medium for drying the ink attached to the printing medium, and an air sending unit that blows air onto the printing medium for drying the ink attached to the printing medium, wherein the ink contains water and an organic solvent S, an amount of the water is 3.0 to 10.0% by mass with respect to a total amount of the ink, the organic solvent S includes an organic solvent A with a boiling point of 150° C. or higher and lower than 200° C., the heating unit heats the printing medium so that a surface temperature of the printing media is 40 to 43° C., and the air sending unit blows air at an air velocity of 0.2 to 1.5 m/sec onto the printing medium.

According to another aspect of the present disclosure, there is provided a method for producing printed matter, comprising the steps of: attaching ink to a non-absorbent or low-absorbent printing medium; heating the printing medium for drying the ink attached to the printing medium; and blowing air onto the printing medium for drying the ink attached to the printing medium, wherein the ink contains water and an organic solvent S, an amount of the water is 3.0 to 10.0% by mass with respect to a total amount of the ink, the organic solvent S includes an organic solvent A with a boiling point of 150° C. or higher and lower than 200° C., the printing medium is heated so that a surface temperature of the printing media is 40 to 43° C. in the step of heating the printing medium, and air at an air velocity of 0.2 to 1.5 m/sec is blown onto the printing medium in the step of blowing air onto the printing medium.

### BRIEF DESCRIPTION OF THE DRAWINGS

FIG. 1 is a schematic block diagram of an inkjet printing device according to a first embodiment;

FIG. 2 is a plan view of main parts of the inkjet printing device shown in FIG. 1;

FIG. 3 is a control block diagram of the inkjet printing device shown in FIG. 1;

FIG. 4 is a diagram showing the measurement results of the OD values of black images in a piece of printed matter of Example 2;

FIG. 5 is a diagram showing the measurement results of the OD values of cyan images in the piece of printed matter of Example 2;

FIG. 6 is a diagram showing the measurement results of the OD values of magenta images in the piece of printed matter of Example 2; and

FIG. 7 is a diagram showing the measurement results of the OD values of yellow images in the piece of printed matter of Example 2.

### DETAILED DESCRIPTION OF THE EMBODIMENTS

If ink containing a highly volatile organic solvent is used, nozzle clogging in an ink jet head and ink adhesion near a nozzle may occur due to volatilization of the organic solvent. This may cause deterioration of image quality due to poor jetting of ink.

Ink containing a highly volatile organic solvent may deteriorate the working environment during printing due to volatilization of the organic solvent. Therefore, it is desirable that ink containing an organic solvent that is not so highly volatile and has high safety be used as ink containing an organic solvent.

Thus, in the case of printing on a non-absorbent or low-absorbent printing medium with an inkjet printing device, ink may be used which contains an organic solvent that is not highly volatile while having high drying properties, so that bleeding of an image can be suppressed.

However, in the case where a printing medium is dried by heating, even the use of such ink may lead to occurrence of nozzle clogging and ink adhesion near a nozzle under the influence of heating of the printing medium, resulting in deterioration of image quality due to poor jetting of ink.

There is a problem that if an organic solvent that is not highly volatile and has a higher boiling point (for example, a boiling point of 200° C. or higher) is used in a large amount, it is necessary to perform drying at a higher temperature in drying by heating, and a printing medium is damaged because of the high temperature.

Therefore, there has been a demand for a technique that is capable of high-quality and high-productivity printing on a non-absorbent or low-absorbent printing medium using ink containing an organic solvent that is not highly volatile.

The present disclosure is made in light of the above, and an object of the present disclosure is to provide an inkjet printing device and a method for producing printed matter, which are capable of high-quality and high-productivity printing on a non-absorbent or low-absorbent printing medium using ink containing an organic solvent that is not highly volatile.

Hereinafter, embodiments of the present disclosure will be described with reference to the drawings. In the drawings, the same or equivalent parts and components are denoted by the same or equivalent reference numerals.

The embodiments described below illustrate devices and the like for implementing the technical idea of this invention, and in the technical idea of this invention, the materials, shapes, structures, arrangements and the like of the components are not limited to those described below. Various changes can be made to the technical idea of this invention within the scope of the claims.

### First Embodiment

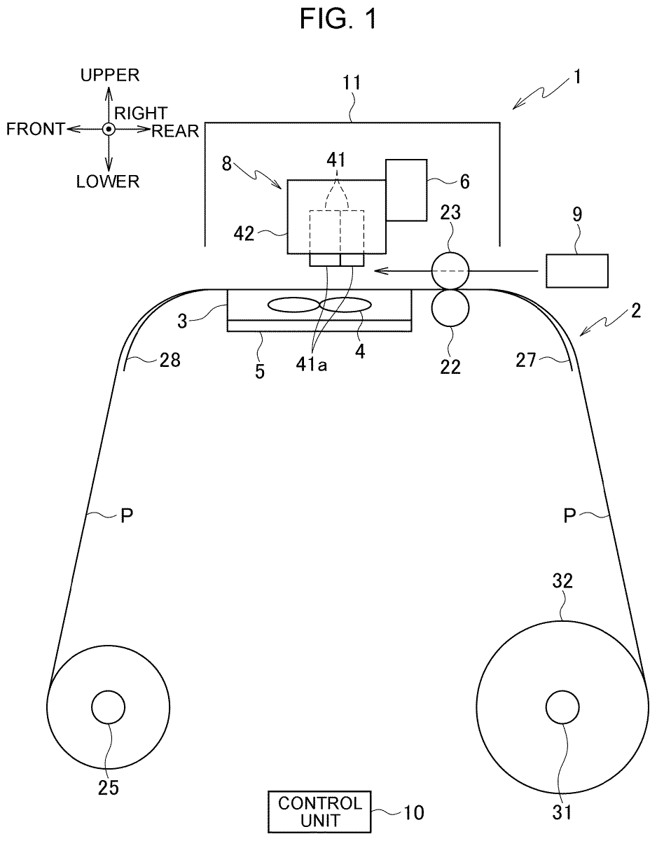

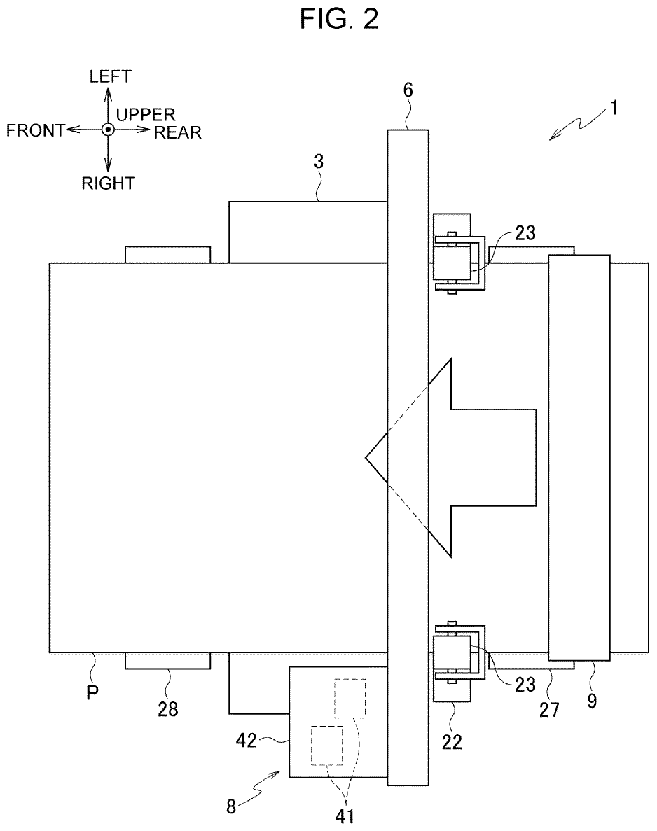

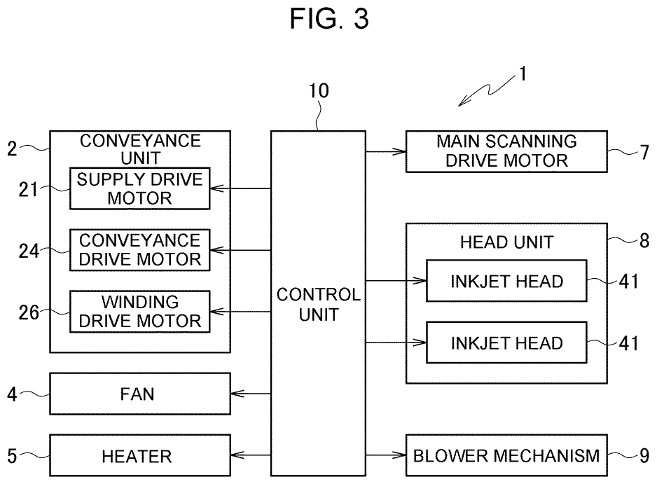

FIG. 1 is a schematic block diagram of an inkjet printing device according to a first embodiment of the present disclosure. FIG. 2 is a plan view of main parts of the inkjet printing device shown in FIG. 1. FIG. 3 is a control block diagram of the inkjet printing device shown in FIG. 1. In the following description, the longitudinal and horizontal directions indicated by arrows in FIG. 1 are the upper and lower and front and rear directions of the inkjet printing device. The direction that is a horizontal direction when viewed from the front side is the horizontal direction of the inkjet printing device.

As shown in FIGS. 1 to 3, an inkjet printing device 1 according to the first embodiment comprises a conveyance unit 2, a platen 3, a fan 4, a heater (corresponding to a heating unit) 5, a main scanning drive guide 6, a main scanning drive motor 7, a head unit 8, a blower mechanism (corresponding to an air sending unit) 9, a control unit 10, and an exterior cover 11 that covers the head unit 8 and the like.

The conveyance unit 2 conveys a strip-shaped printing medium P. In the inkjet printing device 1, a non-absorbent printing medium that does not absorb ink or a low-absorbent printing medium that hardly absorbs ink is used as the printing medium P.

The non-absorbent printing medium is not particularly limited, and examples thereof include sheets, films and textile products containing a non-absorbent material. The non-absorbent printing medium may have a layer containing a non-absorbent material (hereinafter also referred to as a “low-absorbent layer”) on a surface of a substrate (for example, paper, fiber, leather, plastic, glass, ceramics, or metal). The non-absorbent material is not particularly limited, and examples thereof include olefin-based resins, ester-based resins, urethane-based resins, acryl-based resins, and polyvinyl chloride-based resins.

The non-absorbent printing medium is not particularly limited, and examples thereof include films and plates of plastics such as polyvinyl chloride, polyethylene, polypropylene and polyethylene terephthalate (PET), plates of metals such as iron, silver, copper and aluminum, or metal plates and plastic films produced by vapor deposition of any of the metals, and plates of alloys such as stainless steel and brass.

Examples of the low-absorbent printing medium include art paper, coated paper, and cast paper, which are used in common offset printing, and have relatively low permeability to ink. In these printing media, a coating layer having relatively low permeability to ink is provided on a substrate of paper or the like. Such a printing medium is also referred to as coating paper. The coating layer is a layer comprising a resin, an inorganic compound or the like, which has low water absorbency. The layer has low ink absorbency.

As shown in FIGS. 1 to 3, the conveyance unit 2 comprises a supply drive motor 21, a conveyance roller 22, two pinch rollers 23, a conveyance drive motor 24, a winding shaft 25, a winding drive motor 26, and printing medium guides 27 and 28.

The supply drive motor 21 rotates a core 31 of a printing medium roll 32 in which the printing medium P is wound around the core 31 in a roll form. The printing medium roll 32 is arranged below the rear side of the platen 3.

The conveyance roller 22 conveys the printing medium P, which is unwound from the printing medium roll 32, to the platen 3 while nipping the printing medium P between the conveyance roller 22 and the pinch roller 23. The conveyance roller 22 is arranged near the rear side of the platen 3.

The pinch roller 23 comes into pressure contact with the conveyance roller 22 with the printing medium P interposed therebetween, and rotates in synchronization with the conveyance roller 22. The two pinch rollers 23 are arranged at a distance from each other in the horizontal direction above the conveyance roller 22. The left pinch roller 23 nips the left end of the printing medium P between itself and the conveyance roller 22, and the right pinch roller 23 nips the right end of the printing medium P between itself and the conveyance roller 22. The two pinch rollers 23 are configured to be capable of being moved in the horizontal direction, respectively, by motors or the like (not shown). This enables the positions of the two pinch rollers 23 to be adjusted according to a width of the printing medium P.

The conveyance drive motor 24 rotates the conveyance roller 22.

The winding shaft 25 winds up the printing medium P that is unwound from the printing medium roll 32 and conveyed via the platen 3. The winding shaft 25 is arranged below the front side of the platen 3.

The winding drive motor 26 rotates the winding shaft 25.

The printing medium guide 27 guides the printing medium P between the printing medium roll 32 and the conveyance roller 22. The printing medium guide 28 guides the printing medium P between the platen 3 and the winding shaft 25.

The platen 3 supports the printing medium P. The platen 3 is formed in an elongated shape extending in the horizontal direction. In the platen 3, a plurality of suction holes for sucking air are formed.

The fan 4 sucks air through the suction hole of the platen 3 to generate a suction force in the suction hole, thereby adsorbing the printing medium P onto the platen 3.

The heater 5 heats the printing medium P through the platen 3 for drying the ink jetted from the later-described inkjet head 41 and attached to the printing medium P. The heater 5 is arranged on the lower surface of the platen 3.

The heater 5 heats the printing medium P through the platen 3 so that the surface temperature of the printing medium P is 40 to 43° C. By performing heating so that the surface temperature of the printing medium P is 40° C. or higher, bleeding of the image that is caused by insufficient drying of the ink can be suppressed to prevent deterioration of image quality. By performing heating to the extent that the surface temperature of the printing medium P is 43° C. or lower, the occurrence of nozzle clogging and ink adhesion near the nozzle in the inkjet head 41 under the influence of the heating of the printing medium P can be suppressed. This enables suppression of deterioration of image quality due to poor jetting of ink.

The main scanning drive guide 6 guides the head unit 8 to move in the horizontal direction (main scanning direction). The main scanning drive guide 6 is formed in a long shape extending in the horizontal direction.

The main scanning drive motor 7 moves the head unit 8 in the horizontal direction.

The head unit 8 prints an image by jetting ink to the printing medium P while moving in the horizontal direction. As shown in FIGS. 1 to 3, the head unit 8 comprises two inkjet heads 41 and a carriage 42.

The inkjet head 41 jets ink to attach the ink to the printing medium P. The two inkjet heads 41 are arranged at a distance from each other in the horizontal direction, and at different positions in the longitudinal direction.

The inkjet head 41 is formed by a plurality of nozzles (not shown) arranged along the longitudinal direction, and has four rows of nozzles arranged side by side in the horizontal direction. Each nozzle of each row of nozzles in the inkjet head 41 is formed on a nozzle surface 41a which is a lower surface facing the platen 3. Each nozzle of each row of nozzles in the inkjet head 41 jets ink whose color (for example, black (K), cyan (C), magenta (M) or yellow (Y)) varies depending on the row of nozzles. Details of the ink will be described later.

The jetting method of the inkjet head 41 is not particularly limited, and may be any of a piezo method, an electrostatic method, and a thermal method.

The carriage 42 holds the inkjet head 41. The carriage 42 is formed in a hollow box shape. The carriage 42 holds the inkjet head 41 by inserting the lower end of the inkjet head 41 into an opening formed in a bottom plate of the carriage 42.

The blower mechanism 9 blows air onto the printing medium P for drying the ink jetted from the inkjet head 41 and attached to the printing medium P. The blower mechanism 9 is arranged behind the pinch roller 23 at a height equivalent to that of the pinch roller 23, and sends air forward. The air from the blower mechanism 9 passes between the two pinch rollers 23, and is blown onto a region of the printing medium P where the ink jetted from the head unit 8 forms an image.

The blower mechanism 9 blows air at an air velocity of 0.2 to 1.5 m/sec onto the printing medium P. Since the air velocity is 0.2 m/sec or more, bleeding of the image which is caused by insufficient drying of the ink can be suppressed to prevent deterioration of image quality. Since the air velocity is 1.5 m/sec or less, growth of ink mist under the influence of air can be suppressed. This enables suppression of deterioration of image quality which is caused by mist stains generated due to attachment of ink mist to the printing medium P.

The temperature of air blown onto the printing medium P by the blower mechanism 9 is preferably 35 to 40° C. in an environment at 23° C. and 50% RH. This enables inhibiting the surface temperature of the printing medium P from falling outside the range of 40 to 43° C. Thus, it is possible to further suppress deterioration of image quality due to bleeding of the image while further suppressing deterioration of image quality due to poor jetting of ink.

The control unit 10 controls the operation of the entire inkjet printing device 1. The control unit 10 comprises CPU, RAM, ROM, a hard disk and the like.

Next, the ink jetted by the inkjet head 41 will be described.

The ink jetted by the inkjet head 41 in the present embodiment is an inkjet ink containing water and an organic solvent S, in which the amount of the water is 3.0 to 10.0% by mass with respect to the total amount of ink, and the organic solvent S includes an organic solvent A with a boiling point of 150° C. or higher and lower than 200° C.

For example, if an organic solvent with a low boiling point is used to improve the drying properties for improving the image bleeding, the jetting properties of ink from the inkjet head 41 may deteriorate.

The ink jetted by the inkjet head 41 in the present embodiment contains the organic solvent A with a moderate boiling point of 150° C. or higher and lower than 200° C. in the organic solvent S of the ink. The ink contains water, and the amount of the water is 3.0 to 10.0% by mass with respect to the total amount of the ink. It is presumed that since the ink contains water in an amount of 3.0% by mass or more, it is possible to improve the drying properties, which can contribute to reduction of image bleeding. This is considered to be due to an azeotropic phenomenon between the water and the organic solvent. It is presumed that since the amount of water is 10.0% by mass or less with respect to the total amount of ink, it is possible to suppress an increase in ink viscosity, which can contribute to improvement of the jetting properties of ink.

The organic solvent S may contain an organic solvent A with a boiling point of 150° C. or higher and lower than 200° C. in an amount of 90.0% by mass or more with respect to the total amount of the organic solvent S contained in the ink. This enables further improvement of the drying properties of the ink. Since an organic solvent with a low boiling point is not used in a large amount, it is possible to reduce occurrence of poor jetting due to nozzle clogging or ink adhesion near the nozzle. In this way, it is possible to form an image with reduced bleeding while maintaining good jetting properties of ink.

The organic solvent A may contain a water-soluble organic solvent B with a boiling point of 150° C. or higher and lower than 200° C. in an amount of 50.0% by mass or more with respect to the total amount of the organic solvent S in the ink. This enables water to be contained in the ink more stably, so that an increase in ink viscosity can be suppressed.

The ink may contain a colorant. The ink may contain a pigment, a dye, or a combination thereof as the colorant.

Examples of the pigment which can be used include organic pigments such as azo pigments, phthalocyanine pigments, polycyclic pigments, and dye lake pigments, and inorganic pigments such as carbon blacks and metal oxides. Examples of the azo pigment include soluble azo lake pigments, insoluble azo pigments, and condensed azo pigments. Examples of phthalocyanine pigments include metal phthalocyanine pigments and metal-free phthalocyanine pigments. Examples of polycyclic pigments include quinacridone-based pigments, perylene-based pigments, perinone-based pigments, isoindoline-based pigments, isoindolinone-based pigments, dioxazine-based pigments, thioindigo-based pigments, anthraquinone-based pigments, quinophthalone-based pigments, metal complex pigments, and diketopyrrolopyrroles (DPP). Examples of carbon blacks include furnace carbon black, lamp black, acetylene black, and channel black. Examples of metal oxides include titanium oxide and zinc oxide. One of these pigments may be used alone, or a combination of two or more of these pigments may be used.

From the viewpoints of jetting stability and storage stability, the average particle size of pigment particles in the ink, expressed as the volume-based average value in a particle size distribution measured by means of a dynamic light scattering method, is preferably 1 μm or less, more preferably 500 nm or less, and even more preferably 300 nm or less.

The pigment may be blended into the ink in the form of a pigment dispersion. The pigment dispersion may be one in which the pigment can be dispersed in a solvent and in which the pigment can assume a dispersed state in the ink. Examples of pigment dispersion that can be used include one in which a pigment is dispersed in a dispersion medium with a pigment dispersant, and one in which a microencapsulated pigment obtained by coating a pigment with a resin is dispersed in a dispersion medium.

A dispersion form of the pigment may be a dispersion in which what is referred to as an encapsulated pigment in which a pigment is coated with an oil-insoluble resin, or colored resin particles are dispersed with a pigment dispersant, but preferably a dispersion in which a pigment dispersant is directly adsorbed on a pigment surface for dispersion.

In terms of the dye, any dye typically used in the technical field may be optionally used. If the dye exhibits an affinity to a non-aqueous solvent of the ink, the storage stability of the ink becomes more favorable, and therefore it is preferable to use an oil-soluble dye.

Examples of the oil-soluble dye include azo dyes, metal complex salt dyes, naphthol dyes, anthraquinone dyes, indigo dyes, carbonium dyes, quinone imine dyes, xanthene dyes, cyanine dyes, quinoline dyes, nitro dyes, nitroso dyes, benzoquinone dyes, naphthoquinone dyes, phthalocyanine dyes, and metal phthalocyanine dyes. One of these dyes may be used alone, or a combination of two or more of these dyes may be used.

From the viewpoint of the print density and the ink viscosity, the amount of the colorant, relative to the total amount of the ink, is preferably in a range from 0.1% by mass to 20% by mass, more preferably in a range from 1% by mass to 15% by mass, and even more preferably in a range from 5% by mass to 10% by mass.

When the ink contains a pigment, a pigment dispersant can be used together with the pigment, in order to stably disperse the pigment in the ink. There are no particular limitations on the pigment dispersant as long as the pigment can be stably dispersed in the ink. Examples of the pigment dispersant which may be preferably used include: a hydroxyl group-containing carboxylate ester, salts of a long-chain polyaminoamide and a high-molecular weight acid ester, a salt of a high-molecular weight polycarboxylic acid, salts of a long-chain polyaminoamide and a polar acid ester, a high-molecular weight unsaturated acid ester, a copolymer of vinyl pyrrolidone and a long-chain alkene, a modified polyurethane, a modified polyacrylate, a polyether ester-type anionic surfactant, a polyoxyethylene alkyl phosphate ester, and a polyester polyamine.

It is preferable to use a polymeric dispersant as the pigment dispersant. As the polymeric dispersant, a synthesized dispersant may be used, or a commercially available product may be used.

Examples of the commercially available product of the pigment dispersant include “Solsperse J180”, “Solsperse J200”, “Solsperse 71000”, “Solsperse 74000”, “Solsperse 86000”, “Solsperse 87000”, “Solsperse M387”, and the like manufactured by The Lubrizol Corporation, and “BYKJET-9151”, “BYKJET-9152”, “BYKJET-9170”, and the like manufactured by BYK-Chemie Japan K.K. (all product names). These may be used alone, or in combination of two or more thereof.

The pigment dispersant is preferably contained in a mass ratio in a range from 0.2 to 1.0, relative to a value of 1 for the pigment. The amount of the pigment dispersant, relative to the total amount of the ink, is preferably in a range from 0.5% by mass to 15% by mass, and more preferably in a range from 1% by mass to 5% by mass.

The ink may contain a binder resin.

From the viewpoint of forming a uniform ink film and enhancing the adhesion of an image to a substrate, the binder resin is preferably a resin that is dissolved in the organic solvent S contained in the ink.

Examples of the binder resin include a (meth)acrylic resin, a styrene-(meth)acrylic resin, a styrene-maleic acid resin, an ethylene-(meth)acrylic resin, a urethane resin, a vinyl chloride resin, a vinyl chloride-vinyl acetate resin, a polyester resin, a polyvinyl alcohol resin, an epoxy resin, and a polyvinylpyrrolidone resin.

From the viewpoint of enhancing the adhesion of an image to a substrate, a (meth)acrylic resin is preferable as the binder resin. The binder resin is more preferably a (meth)acrylic resin that is soluble in the organic solvent S. When a (meth)acrylic resin is used, it is possible to improve the adhesion of the image to a plastic substrate including an olefin resin or the like. In particular, an olefin resin tends to have a low affinity to an organic solvent in an ink, and it is sometimes difficult to obtain adhesion of an image. However, if a (meth)acrylic resin is used, the adhesion of an image to a substrate can be easily enhanced.

A (meth)acrylic resin may be a resin with at least one unit selected from the group consisting of a unit derived from (meth)acrylic acid, and a unit derived from a (meth)acrylate ester, for example.

In the present disclosure, (meth)acrylic acid collectively means acrylic acid and methacrylic acid. A (meth)acrylate ester collectively means an acrylate ester and a methacrylate ester. (Meth)acrylate collectively means acrylate and methacrylate.

Examples of (meth)acrylate esters include alkyl (meth)acrylate esters, benzyl (meth)acrylate, and hydroxyalkyl (meth)acrylate. Examples of the alkyl (meth)acrylate ester include an alkyl (meth)acrylate ester with an alkyl group of 1 to 8 carbon atoms, 1 to 6 carbon atoms, or 1 to 4 carbon atoms. Specific examples thereof include methyl (meth)acrylate, ethyl (meth)acrylate, butyl (meth)acrylate, and 2-ethylhexyl (meth)acrylate.

The (meth)acrylic resin may be a polymer of one or more monomers selected from the group consisting of (meth)acrylic acid and a (meth)acrylate ester, for example.

Examples of the (meth)acrylic resin include poly(meth)acrylic acid, a poly(meth)acrylate ester (for example, poly(methyl (meth)acrylate), poly(ethyl (meth)acrylate), poly(butyl (meth)acrylate), and the like), a (meth)acrylate ester copolymer resin, and a (meth)acrylic acid-(meth)acrylate ester copolymer resin.

It is preferable that the (meth)acrylic resin contain, for example, units derived from an alkyl (meth)acrylate ester. The amount of the unit derived from an alkyl (meth)acrylate ester may be, for example, 50.0% by mass or more, 70.0% by mass or more, or 90.0% by mass or more, relative to the total unit of the (meth)acrylic resin.

Specific examples of the (meth)acrylic resin include a polymer of methyl (meth)acrylate, and a copolymer of methyl (meth)acrylate and at least one selected from the group consisting of (meth)acrylic acid, ethyl (meth)acrylate, butyl (meth)acrylate, 2-ethylhexyl (meth)acrylate, 2-hydroxyethyl (meth)acrylate, and benzyl (meth)acrylate (for example, a copolymer of 100 parts by mass of methyl methacrylate and 0.1 to 200 parts by mass, 1 to 180 parts by mass, or 10 to 150 parts by mass of at least one selected from the group consisting of methacrylic acid, butyl methacrylate, and benzyl methacrylate).

A glass transition temperature (Tg) of the (meth)acrylic resin may be 60° C. or higher, for example. From the viewpoint of enhancing the adhesion of an image to a substrate, the glass transition temperature (Tg) is preferably 80° C. or higher, and more preferably 100° C. or higher. The glass transition temperature of the (meth)acrylic resin may be, for example, 200° C. or lower. The glass transition temperature of the (meth)acrylic resin may be, for example, 60 to 200° C., 80 to 200° C., or 100 to 200° C. In the present disclosure, the glass transition temperature is an estimated value determined from the FOX equation.

The weight average molecular weight of the (meth)acrylic resin is preferably in a range from 5,000 to 150,000, and is more preferably in a range from 10,000 to 100,000. From the viewpoint of water resistance and durability, the weight average molecular weight of the (meth)acrylic resin is preferably 5,000 or more, and more preferably 10,000 or more. From the viewpoint of ink viscosity and jetting properties, the weight average molecular weight of the (meth)acrylic resin is preferably 150,000 or less, and more preferably 100,000 or less. In the present disclosure, the weight average molecular weight is a value obtained by the GPC method using standard polystyrene conversion.

As the (meth)acrylic resin, a synthetic resin may be used, or a commercially available resin may be used.

The method for synthesizing a (meth)acrylic resin is not particularly limited. The (meth)acrylic resin may be obtained by polymerizing one or two or more radical polymerizable monomers by means of solution polymerization or the like, for example. At least one monomer selected from the group consisting of (meth)acrylic acid and a (meth)acrylate ester may be polymerized, for example.

Although there are no particular limitations on a polymerization solvent (reaction solvent) used for the solution polymerization, it is preferable to use a solvent in which the (meth)acrylic resin obtained by polymerizing the monomers can be dissolved. The organic solvent S or the organic solvent A contained in the ink may be used as the polymerization solvent, from the viewpoint of the compatibility between the obtained (meth)acrylic resin and the organic solvent in the ink, and the preparation of the ink with a low viscosity thereby. When the ink contains two or more organic solvents as the organic solvent S or the organic solvent A, only one of them may be used as the polymerization solvent, for example.

A polymerization initiator, such as a radical polymerization initiator, may be used for performing a polymerization reaction.

As the radical polymerization initiator, it is possible to use known radical polymerization initiators including azo compounds such as 2,2′-azobis(isobutyronitrile) (AIBN), 2,2′-azobis(2,4′-dimethylvaleronitrile), and dimethyl 2,2′-azobisisobutyrate, and organic peroxides such as hydroperoxide-based compounds, dialkyl peroxide-based compounds, peroxyester-based compounds, and diallyl peroxide-based compounds. These may be used alone, or in combination of two or more thereof.

As the (meth)acrylic resin, it is preferable to use an acrylic resin obtained by solution polymerization of one or more radical polymerizable monomers with a radical polymerization initiator in the organic solvent S or the organic solvent A used in the ink, from the viewpoint of favorable compatibility between the (meth)acrylic resin and the solvent, and the preparation of an ink with a low viscosity thereby. For example, when the ink contains two or more organic solvents as the organic solvent S or the organic solvent A, the (meth)acrylic resin may be a resin obtained by solution polymerization using only one of the organic solutions as a polymerization solvent.

Examples of commercially available products of the (meth)acrylic resin include “Neocryl B-728” and “Neocryl B-801” manufactured by Covestro AG, and “Dianal BR-83”, “Dianal BR-87”, and “Dianal MB-7333” manufactured by Mitsubishi Chemical Corporation (all product names).

The amount of the binder resin may be 1.0% by mass or more or 3.0% by mass or more, relative to the total amount of the ink, for example. Meanwhile, the amount of the binder resin may be 40.0% by mass or less, 30.0% by mass or less, or 20.0% by mass or less, relative to the total amount of the ink, for example. The amount of the binder resin may be in a range from 1.0% by mass to 40.0% by mass, in a range from 1.0% by mass to 30.0% by mass, or in a range from 3.0% by mass to 20.0% by mass, relative to the total amount of the ink, for example.

The ink may contain water.

There are no particular limitations on the water, but it is preferably water in which ionic components are as minimal as possible. In particular, from the viewpoint of the storage stability of the ink, it is preferable that the amount of contained polyvalent metal ions such as calcium is small. Ion-exchanged water, distilled water, ultrapure water, or the like may be used as the water, for example.

From the viewpoint of reducing image bleeding, the amount of the water is preferably 3.0% by mass or more, more preferably 4.0% by mass or more, and even more preferably 4.5% by mass or more, relative to the total amount of the ink. When the amount of the water is 3.0% by mass or more, relative to the total amount of the ink, the drying properties of the ink are enhanced, and when printing on roll paper, transfer of an image during winding after printing can be suppressed. Meanwhile, from the viewpoint of enhancing the ink jetting properties, the amount of the water is preferably 10.0% by mass or less, more preferably 9.0% by mass or less, and even more preferably 8.0% by mass or less, relative to the total amount of the ink. The amount of the water is preferably in a range from 3.0% by mass to 10.0% by mass, more preferably in a range from 4.0% by mass to 9.0% by mass, and even more preferably in a range from 4.5% by mass to 8.0% by mass, relative to the total amount of the ink.

The amount of the water in the ink may be equal to the amount of water actively blended into the ink. Meanwhile, when an organic solvent having affinity with water is blended into the ink, the organic solvent may absorb water vapor or the like in the atmosphere, for example. In such a case, the amount of the water blended into the ink may not be equal to the amount of the water in the ink.

The amount of the water in the ink may be measured by means of the Karl Fischer method, for example.

The ink may contain the organic solvent S. Examples of the organic solvent S include an organic solvent (organic solvent A) with a boiling point of 150° C. or higher and lower than 200° C., and other organic solvents. Examples of other organic solvents include an organic solvent with a boiling point of lower than 150° C., and an organic solvent with a boiling point of 200° C. or higher. Examples of the organic solvent with a boiling point of lower than 150° C. include ethylene glycol monomethyl ether acetate. Examples of the organic solvent with a boiling point of 200° C. or higher include γ-butyrolactone, and 2-pyrrolidone. The ink may contain one or two or more of the other organic solvents.

The organic solvent (organic solvent A) with a boiling point of 150° C. or higher and lower than 200° C., may be any of a ketone-based organic solvent, an alcohol-based organic solvent, a glycol ether-based organic solvent, an acetate-based organic solvent, and the like. One organic solvent A may be used alone, or a combination of two or more thereof may be used.

From the viewpoint of reducing image bleeding, the boiling point of the organic solvent A is preferably lower than 200° C., and more preferably 195° C. or lower. Meanwhile, from the viewpoint of enhancing the ink jetting properties, the boiling point of the organic solvent A is preferably 150° C. or higher, more preferably 160° C. or higher, and even more preferably 170° C. or higher.

The organic solvent A may contain a water-soluble organic solvent (water-soluble organic solvent B) with a boiling point of 150° C. or higher and lower than 200° C., and the organic solvent A may further contain a water-insoluble organic solvent with a boiling point of 150° C. or higher and lower than 200° C.

Examples of the water-soluble organic solvent B in the organic solvent A, include diethylene glycol diethyl ether, diethylene glycol ethyl methyl ether, diethylene glycol isopropyl methyl ether, diethylene glycol dimethyl ether, ethylene glycol monobutyl ether, diethylene glycol monoethyl ether, diethylene glycol monomethyl ether, dipropylene glycol monomethyl ether, 3-methoxy-3-methyl-1-butanol, 3-methoxy-1-butanol, diethylene glycol monoethyl ether acetate, and 1,2-propanediol. These may be used alone, or in combination of two or more thereof.

Examples of the water-insoluble organic solvent with a boiling point of 150° C. or higher and lower than 200° C. in the organic solvent A include ethylene glycol monobutyl ether acetate, ethylene glycol diacetate, dipropylene glycol dimethyl ether, propylene glycol 1-monobutyl ether, butyl lactate, hexyl propionate, and ethyl 3-ethoxypropionate. One water-insoluble organic solvent with a boiling point of 150° C. or higher and lower than 200° C. may be used alone, or a combination of two or more thereof may be used.

From the viewpoint of enhancing the ink jetting properties and suppressing image bleeding, the amount of the organic solvent A is preferably 90.0% by mass or more, more preferably 95.0% by mass or more, and even more preferably 99.0% by mass or more, relative to the total amount of the organic solvent S contained in the ink. The amount of the organic solvent A may be 100% by mass, relative to the total amount of the organic solvent S contained in the ink. The amount of the organic solvent A may be in a range from 90.0% by mass to 100% by mass, in a range from 95.0% by mass to 100% by mass, or in a range from 99.0% by mass to 100% by mass, relative to the total amount of the organic solvent S contained in the ink, for example.

From the viewpoint of enhancing the ink jetting properties, the amount of the water-soluble organic solvent B is preferably 50.0% by mass or more, more preferably 60.0% by mass or more, even more preferably 70.0% by mass or more, even more preferably 80.0% by mass or more, and even more preferably 90.0% by mass or more, relative to the total amount of the organic solvent S contained in the ink. The amount of the water-soluble organic solvent B may be 100% by mass, relative to the total amount of the organic solvent S contained in the ink, for example. The amount of the water-soluble organic solvent B may be in a range from 50.0% by mass to 100% by mass, in a range from 60.0% by mass to 100% by mass, in a range from 70.0% by mass to 100% by mass, in a range from 80.0% by mass to 100% by mass, or in a range from 90.0% by mass to 100% by mass, relative to the total amount of the organic solvent S contained in the ink, for example.

From the viewpoint of making the binder resin stably exist in the ink, suppressing an increase in the viscosity of the ink, and further enhancing the jetting properties, the water-soluble organic solvent B preferably contains a water-soluble organic solvent Bx having a Hansen solubility parameter (HSP value) of 25.0 MPa^{1/2} or less, and a boiling point of 150° C. or higher and lower than 200° C.

The HSP value of the water-soluble organic solvent Bx may be 23.0 MPa^{1/2} or less, for example. Meanwhile, the HSP value of the water-soluble organic solvent Bx may be 10.0 MPa^{1/2} or more or 15.0 MPa^{1/2} or more, for example. The HSP value of the water-soluble organic solvent Bx may be 10.0 to 25.0 MPa^{1/2} or 15.0 to 23.0 MPa^{1/2}, for example.

The Hansen solubility parameter was proposed by Hansen in 1967. The solubility parameter introduced by Hildebrand was divided into 3 components, a dispersion term 8D, a polar term &p, and a hydrogen bond term 8H, and expressed in a three-dimensional space. The dispersion term indicates an effect by the dispersion force, the polar term indicates an effect by the dipole-dipole force, and the hydrogen bond term indicates an effect of the hydrogen bonding force.

The details are explained in POLYMER HANDBOOK. FOURTH EDITION. (Editors. J. BRANDRUP, E. H. IMMERGUT, and E. A. GRULKE.).

The present disclosure uses values obtained by calculation using calculation software for Hansen solubility parameters proposed by Charles. M. Hansen et al. “HSPIP: Hansen Solubility Parameters in Practice” ver. 5.3.

Examples of the water-soluble organic solvent Bx include diethylene glycol diethyl ether, diethylene glycol ethyl methyl ether, diethylene glycol isopropyl methyl ether, diethylene glycol dimethyl ether, ethylene glycol monobutyl ether, diethylene glycol monoethyl ether, diethylene glycol monomethyl ether, dipropylene glycol monomethyl ether, 3-methoxy-3-methyl-1-butanol, 3-methoxy-1-butanol, and diethylene glycol monoethyl ether acetate. These may be used alone, or in combination of two or more thereof.

From the viewpoint of further enhancing the jetting properties, the amount of the water-soluble organic solvent Bx is preferably 50.0% by mass or more, more preferably 75.0% by mass or more, even more preferably 80.0% by mass or more, or even more preferably 90.0% by mass or more, relative to the total amount of the water-soluble organic solvent B. Meanwhile, the amount of the water-soluble organic solvent Bx may be 100% by mass, relative to the total amount of the water-soluble organic solvent B. The amount of the water-soluble organic solvent Bx may be in a range from 50.0% by mass to 100% by mass, in a range from 75.0% by mass to 100% by mass, in a range from 80.0% by mass to 100% by mass, or in a range from 90.0% by mass to 100% by mass, relative to the total amount of the water-soluble organic solvent B, for example.

The ink preferably contains a surfactant. From the viewpoint, for example, of making the wet spreading of the ink favorable even on a surface of a substrate with hydrophobicity, and increasing a drying speed to form a favorable image, the ink preferably contains a surfactant. Examples of the surfactant include a silicone-based surfactant, a fluorine-based surfactant, and a polyoxyethylene derivative that is a nonionic surfactant.

Examples of the silicone-based surfactant include polyester-modified silicone, and polyether-modified silicone. Examples of commercially available products of the silicone-based surfactant include “BYK-307”, “BYK-313”, “BYK-330”, “BYK-333”, “BYK-342”, “BYK-370”, “BYK-377”, “BYK-378”, “BYK-3550”, “BYK-3750”, “BYK-3761”, “BYK-3762”, “BYK-3764” and “BYK-SILCLEAN 3700” manufactured by BYK-Chemie Japan K.K., and “Silface SAG005”, “Silface SAG008”, and “Silface SAG503A” manufactured by Nissin Chemical Industry Co., Ltd. (all product names).

Examples of commercially available products of the fluorine-based surfactant include “BYK-340” manufactured by BYK-Chemie Japan K.K., and “SURFLON S-241”, “SURFLON S-242”, “SURFLON S-242L”, “SURFLON S-243” “SURFLON S-420”, and “SURFLON S-431” manufactured by AGC Seimi Chemical Co., Ltd. (all product names).

As the polyoxyethylene derivatives, it is preferable to use acetylene glycol-based surfactants. Examples of commercially available products of the acetylene glycol-based surfactants include “SURFYNOL 420”, “SURFYNOL 440”, “SURFYNOL 465”, and “SURFYNOL 485” manufactured by Evonik Industries AG, and “OLFINE E-1004” and “OLFINE-1010” manufactured by Nissin Chemical Industry Co., Ltd. (all product names).

The ink preferably contains a silicone-based surfactant, from the viewpoints of continuous jetting properties during printing and color development properties of an image.

One surfactant may be used alone, or two or more surfactants may be used in combination.

The amount of the surfactant is preferably in a range from 0.05% by mass to 2% by mass, and more preferably in a range from 0.1% by mass to 1% by mass, relative to the total amount of the ink.

The ink may contain various additives depending on usage application. Examples of the additives include a UV absorber, a light stabilizer, an antioxidant, and a plasticizer.

There are no particular limitations on a method for producing the inks, but as one method, each component can be mixed and stirred, either in a single batch or in a number of separate batches, to produce the inks. More specifically, the inks can be produced by using a dispersion device such as a bead mill, to disperse all components, either in a single batch or in a number of separate batches, and then passing the dispersion through a filtration device such as a membrane filter if desired, for example.

In the method for producing the inks, a pigment may be mixed and stirred with a pigment dispersant, an organic solvent, and the like, to produce a pigment dispersion in advance, for example.

The suitable range of the viscosity of the inkjet ink varies depending on, for example, a diameter of a nozzle in the inkjet head 41, a jetting environment, and the like. Generally, the viscosity is preferably in a range from 3 mPa·s to 30 mPa·s, more preferably in a range from 3 mPa·s to 15 mPa·s, and even more preferably in a range from 4 mPa·s to 10 mPa·s, at 23° C. In the present disclosure, the ink viscosity is a numerical value obtained through measurement at 23° C. As a viscosity measuring apparatus, it is possible to use “Rheometer MCR302” manufactured by Anton Paar Japan K.K., for example.

Next, the operation of the inkjet printing device 1 will be described.

Upon being instructed to start printing, the control unit 10 starts driving of the fan 4, the heater 5 and blower mechanism 9.

Here, the control unit 10 controls the heater 5 so that the surface temperature of the printing medium P is 40 to 43° C.

The control unit 10 controls the blower mechanism 9 so as to blow air at an air velocity of 0.2 to 1.5 m/sec onto the printing medium P. Here, in an environment at 23° C. and 50% RH, the temperature of the air blown onto the printing medium P by the blower mechanism 9 is preferably 35 to 40° C.

Subsequently, the control unit 10 controls the inkjet head 41 on the basis of image data to be printed, to jet ink while controlling the main scanning drive motor 7 to move the head unit 8, thereby attaching the ink to the printing medium P to perform a first pass of printing.

When the first pass of printing operation is completed, the control unit 10 causes the conveyance unit 2 to convey the printing medium P forward by a predetermined amount of movement.

Subsequently, the control unit 10 controls the inkjet head 41 on the basis of image data to jet ink while moving the head unit 8 in a direction opposite to that during the first pass of printing operation, thereby performing a second pass of printing.

When the second pass of printing operation is completed, the control unit 10 causes the conveyance unit 2 to convey the printing medium P forward by a predetermined amount of movement.

Thereafter, the control unit 10 alternates between one pass of printing operation and movement of the printing medium P, which are the same as above, thereby performing printing on the printing medium P.

Here, on the platen 3, the printing medium P is heated by the heater 5 through the platen 3, and thus, the organic solvent and water contained in the ink attached to the printing medium P vaporize. The vaporized organic solvent is removed from near the surface of a printed region of the printing medium P by the air from the blower mechanism 9. Accordingly, saturation of the concentration of the organic solvent near the surface of the printed region of the printing medium is suppressed, and the ink dries. The drying properties of the ink are improved by an azeotropic phenomenon between water and the organic solvent because the ink contains water in an amount of 3.0% by mass with respect to the total amount of ink as described above. The resin contained in the ink is concentrated, dried and fixed to the printing medium P. In this way, the drying properties of the ink are maintained.

Since the printing medium P is heated by the heater 5 so that the surface temperature thereof is 40° C. or higher, and the air velocity of air from the blower mechanism 9 is 0.2 m/sec or more, bleeding of the image which is caused by insufficient drying of the ink is suppressed to prevent deterioration of image quality.

By performing heating to the extent that the surface temperature of the printing medium P is 43° C. or lower, the occurrence of nozzle clogging and ink adhesion near the nozzle in the inkjet head 41 under the influence of the heating of the printing medium P is suppressed to prevent deterioration of image quality due to poor jetting of ink as described above.

Since the air velocity of air from the blower mechanism 9 is 1.5 m/sec or less, growth of ink mist under the influence of air is suppressed to prevent deterioration of the image that is caused by mist stains.

When the last pass of printing operation is completed, a series of operations ends. In this way, printed matter is produced.

As described above, the inkjet printing device 1 comprises the heater 5 that heats the printing medium P through the platen 3 for drying ink, and the blower mechanism 9 that blows air onto the printing medium P for drying the ink. The heater 5 heats the printing medium P so that the surface temperature of the printing medium P is 40 to 43° C. Thus, it is possible to suppress deterioration of image quality due to bleeding of the image while suppressing deterioration of image quality due to poor jetting of ink. The blower mechanism 9 blows air at an air velocity of 0.2 to 1.5 m/sec onto the printing medium P. Thus, it is possible to suppress deterioration of image quality due to bleeding of the image while suppressing deterioration of image quality that is caused by mist stains.

By drying ink attached to the printing medium P using the heater 5 and the blower mechanism 9, high-productivity printing can be performed.

Therefore, the inkjet printing device 1 is capable of high-quality and high-productivity printing on a non-absorbent or low-absorbent printing medium P using ink containing an organic solvent that is not highly volatile.

By using the heater 5 and the blower mechanism 9, the ink can be dried in a short time even by heating at a relatively low temperature which maintains the surface temperature of the printing medium P at 40 to 43° C. Thus, damage to the printing medium P can be minimized.

In an environment at 23° C. and 50% RH, by ensuring that the temperature of air blown onto the printing medium P by the blower mechanism 9 is 35 to 40° C., the surface temperature of the printing medium P can be inhibited from falling outside the range of 40 to 43° C. as described above. Thus, it is possible to further suppress deterioration of image quality due to bleeding of the image while further suppressing deterioration of image quality due to poor jetting of ink.

### Second Embodiment

Next, a second embodiment in which part of the first embodiment described above is modified will be described.

In the second embodiment, the control unit 10 sets printing conditions according to a printing width, which is the width of a printed image in the main scanning direction (horizontal direction), during printing.

The printing conditions in the second embodiment include an amount of ink droplets jetted by the inkjet head 41, a correspondence relationship between the input and output values of the image data to be printed, and a maximum ink amount.

The amount of ink droplets is a size of one ink droplet (amount of ink) jetted from a nozzle of the inkjet head 41. For example, if the jetting method of the inkjet head 41 is a piezo method, the amount of the ink droplet can be adjusted by controlling one or both of a drive waveform and a drive voltage of a piezo element.

The input value indicates a gradation density in image data. In this embodiment, the input value is an input value after color adjustment based on the color profile. The output value is a value obtained by adjusting the input value according to a printing width. The jetting of ink by the inkjet head 41 is performed on the basis of the output value.

For example, when the amount of cyan ink applied is set to an amount applied at which the input value is 60% at maximum, an adjustment is made so that with respect to cyan, an input value of 60% to 100% corresponds to an output value of 60%.

The maximum ink amount is a maximum amount of ink which the inkjet head 41 jets per unit area.

Here, as described above, the inkjet printing device 1 performs printing on the printing medium P by alternating between one pass of printing operation and movement of the printing medium P in a direction from the rear side to the front side (a sub-scanning direction).

Here, in each pass of printing operation, the inkjet head 41 jets ink to the printing medium P while moving (scanning) by a printing width in the main scanning direction. Therefore, the inkjet head 41 performs reciprocating scanning within the printing width in the main scanning direction.

The inkjet printing device 1 performs printing by a multi-pass method in which the inkjet head 41 scans one region two or more times to print on the region.

That is, the control unit 10 controls the inkjet head 41, the main scanning drive motor 7 (corresponding to a drive unit) and the conveyance unit 2 to perform printing through a multi-pass method by alternating between the operation of jetting ink from the inkjet head 41 to the printing medium P while moving the inkjet head 41 by a printing width in the main scanning direction and the operation of conveying the printing medium P in the sub-scanning direction orthogonally crossing the main scanning direction.

In the inkjet printing device 1 that makes the inkjet head 41 perform reciprocating scanning within a printing width to print by a multi-pass method, ink having high drying properties is used as described above. Thus, the image quality may vary depending on a printing width when the printing conditions are the same. This is particularly marked in solid portions. For example, when the printing width is small, the solid portion can be filled with dots, but if the printing width is large, it may be impossible to sufficiently fill the solid portion with dots, resulting in failure to obtain a sufficient density.

The reason why the image quality varies depending on a printing width is that the amount of ink applied to the printing region per unit time varies depending on a printing width. When the inkjet head 41 performs reciprocating scanning within the printing width to print by a multi-pass method as described above, the amount of ink applied to the printing region per unit time decreases as the printing width increases.

Thus, the larger the printing width, the higher the rate at which the ink applied to the printing medium P dries. Ink which has high drying properties and is used for the inkjet printing device 1 is easily influenced by the printing width. As a result, if the print width is large, the dots may become small, so that the solid portion cannot be sufficiently filled with dots as described above.

Thus, in the second embodiment, the control unit 10 sets printing conditions according to a printing width as described above.

Printing conditions appropriate to the printing width are determined using the results of test printing. The test printing is performed as a preparation before actual printing is carried out with the inkjet printing device 1. The test printing is performed at the same printing resolution as in the actual printing.

The test printing may be performed with a printing width different from that in actual printing. For example, when the actual printing width is relatively large, test printing may be performed with a printing width smaller than that in actual printing for reducing paper waste. For example, when the actual printing width is relatively small, and an image to be printed includes characters with a small size or thin lines, the image may be enlarged to perform test printing with a printing width larger than that in actual printing.

If test printing is performed with a printing width smaller than that in actual printing, and actual printing is performed under printing conditions that have yielded good image quality in the test printing, it may be impossible to sufficiently fill the solid portion with dots, leading to a decrease in density. On the other hand, if test printing is performed with a printing width larger than that in actual printing, and actual printing is performed under printing conditions that have yielded good image quality in the test printing, bleeding may occur in the solid portion.

The reason why image quality deteriorates if actual printing is performed with a printing width different from that in test printing as described above is that the amount of ink applied to the printing region per unit time varies depending on a printing width. Accordingly, the dot diameter of a low-resolution area, the degree of bleeding at a boundary between dots, and the maximum amount of ink that the printing medium P can tolerate vary depending on a printing width. As a result, even under printing conditions that have yielded good image quality with a printing width in test printing, image quality may deteriorate if the printing width is changed in actual printing.

Thus, in the inkjet printing device 1, when actual printing is performed with a printing width different from that in test printing, printing conditions different from printing conditions that have yielded good image quality in the test printing are set in the actual printing.

In test printing, printing is performed under a plurality of kinds of printing conditions, and the user confirms the respective printing results. Here, the user gives the instructions for test printing and actual printing to the inkjet printing device 1 by operating an external terminal such as a personal computer (not shown). In test printing and actual printing, the heater 5 and the blower mechanism 9 are driven in the same manner as in printing in the first embodiment described above.

The user performs an operation on the external terminal to instruct the inkjet printing device 1 to set the printing conditions judged to yield good image quality in the test printing, as printing conditions for the printing width set in the test printing. Upon this, the control unit 10 of the inkjet printing device 1 sets the printing conditions judged by the user to yield good image quality in the test printing, as printing conditions appropriate to the test printing width.

When the actual printing width is identical to the test printing width, the control unit 10 of the inkjet printing device 1 executes actual printing under the printing conditions set as printing conditions appropriate to the test printing width. Here, the actual printing is performed at the same printing resolution as in the test printing as described above.

When the actual printing width is different from the test printing width, the control unit 10 sets printing conditions obtained by changing printing conditions set as printing conditions appropriate to the test printing width, and executes the actual printing.

Specifically, when the actual printing width is larger than the test printing width, the control unit 10 performs at least one operation selected from the group consisting of increasing the amount of ink droplets, changing the correspondence relationship between input and output values of image data so that the output value becomes larger, and increasing the maximum ink amount. This enables reduction of a decrease in density of the solid portion of the printed image.

When the actual printing width is smaller than the test printing width, the control unit 10 performs at least one operation selected from the group consisting of decreasing the amount of ink droplets, changing the correspondence relationship between input and output values of image data so that the output value becomes smaller, and decreasing the maximum ink amount. This enables reduction of bleeding of the solid portion of the printed image.

When at least one selected from the group consisting of the amount of ink droplets, the correspondence relationship between input and output values of image data, and the maximum ink amount is changed according to a printing width as described above, the degree of the change is adjusted so that the amount of ink applied to the printing region with the actual printing width is equivalent to that in printing under printing conditions set as printing conditions appropriate to the test printing width.

Here, when the printing medium type more easily absorbs ink, ink applied to the printing medium P dries at a higher rate, and the density of the solid portion of the printed image is more likely to decrease. Thus, when in actual printing, printing is performed on a type of printing medium P which is different from that in test printing, the control unit 10 may further change, according to the printing medium type, the printing conditions modified according to the printing width as described above, depending on a printing medium type in the actual printing. That is, the control unit 10 sets printing conditions further according to a printing medium type.

For example, when a printing medium type for actual printing more easily absorbs ink than the printing medium type for test printing, the control unit 10 performs at least one operation selected from the group consisting of increasing the amount of ink droplets, changing the correspondence relationship between input and output values of image data so that the output value becomes larger, and increasing the maximum ink amount, with respect to the printing conditions that have been changed according to the printing width as described above.

For example, when a printing medium type for actual printing less easily absorbs ink than a printing medium type for test printing, the control unit 10 performs at least one operation selected from the group consisting of decreasing the amount of ink droplets, changing the correspondence relationship between input and output values of image data so that the output value becomes smaller, and decreasing the maximum ink amount, with respect to the printing conditions that have been changed according to the printing width as described above.

When at least one selected from the group consisting of the amount of ink droplets, the correspondence relationship between input and output values of image data, and the maximum ink amount is changed according to a printing medium type as described above, the degree of the change is adjusted according to the ink absorbency of the printing medium type.

In the second embodiment, the control unit 10 sets the printing conditions according to a printing width in the main scanning direction as described above. This enables suppression of a change in amount of ink applied to the printing region per unit time due to a difference in printing width. As a result, it is possible to reduce deterioration of image quality.

The control unit 10 also sets the printing conditions further according to a printing medium type. This enables the printing conditions to be adjusted according to ink absorbency of the printing medium type, so that deterioration of image quality can be further reduced.

In the second embodiment, the printing conditions include an amount of ink droplets jetted by the inkjet head 41, a correspondence relationship between the input and output values of the image data, and a maximum ink amount. This enables the control unit 10 to adjust the amount of ink applied to the printing area per unit time with accuracy.

Here, as described above, in the second embodiment, test printing is performed at same printing resolution as in actual printing, and on the basis of the results of the test printing, printing conditions appropriate to the printing width are set. The lower the printing resolution, the more easily the ink applied to the printing medium P dries. Thus, even with the same printing width, the printing conditions that yield good image quality in test printing may vary depending on the printing resolution. Therefore, it can be said that the control unit 10 sets the printing conditions also according to a printing resolution. This enables further reduction of deterioration of image quality.

### Other Embodiments

As described above, the first and second embodiments of the present disclosure have been described, but the discussions and drawings that form part of this disclosure should not be construed as limiting this invention. From this disclosure, various alternative embodiments, examples and operational techniques will become apparent to those skilled in the art.

In the first embodiment described above, the inkjet printing device 1 is of serial type, but it may be of line type.

In the second embodiment described above, a table in which the printing resolution, the printing medium type, the printing width, and the printing conditions are associated may be stored in advance. Here, when printing is performed, the control unit 10 acquires printing conditions on basis of the printing resolution, the printing medium type and the printing width using the table as a reference, sets the acquired printing conditions, and executes the printing.

In the second embodiment described above, the user may operate an external terminal or an operation input unit (not shown) of the inkjet printing device 1 to input printing conditions appropriate to the printing width, and the control unit 10 may set the input printing conditions and execute the printing.

In the second embodiment described above, printing conditions were set according to the type of printing medium and printing resolution in addition to the printing width. However, one or both of the printing medium type and the printing resolution as elements for use in setting of the printing conditions may be omitted.

In the second embodiment described above, one or two of the printing conditions used, including the amount of ink droplets jetted by the inkjet head 41, the correspondence relationship between the input and output values of the image data, and the maximum ink amount, may be omitted. Other elements may be included in the printing conditions.

The present disclosure is not limited to the embodiments themselves, and can be implemented with components modified in the practical phase without departing from the gist of the present disclosure. Various inventions can be formed by appropriately combining a plurality of components disclosed in the embodiments. For example, some components may be removed from all the components shown in the embodiments.

### Supplemental

Several embodiments of the present disclosure are listed below.

### (Supplemental 1)

An inkjet printing device comprising:
an inkjet head that jets ink to attach the ink to a non-absorbent or low-absorbent printing medium;
a heating unit that heats the printing medium for drying the ink attached to the printing medium; and
an air sending unit that blows air onto the printing medium for drying the ink attached to the printing medium,
wherein
the ink contains water and an organic solvent S,
an amount of the water is 3.0 to 10.0% by mass with respect to a total amount of the ink,
the organic solvent S includes an organic solvent A with a boiling point of 150° C. or higher and lower than 200° C.,
the heating unit heats the printing medium so that a surface temperature of the printing medium is 40 to 43° C., and
the air sending unit blows air at an air velocity of 0.2 to 1.5 m/sec onto the printing medium.

### (Supplemental 2)

The inkjet printing device according to supplemental 1, wherein the air sending unit blows air at an air temperature of 35 to 40° C. onto the printing medium in an environment of 23° C. and 50% RH.

### (Supplemental 3)

3. The inkjet printing device according to supplemental 1, wherein the organic solvent A with a boiling point of 150° C. or higher and lower than 200° C. includes a water-soluble organic solvent B with a boiling point of 150° C. or higher and lower than 200° C.

### (Supplemental 4)

The inkjet printing device according to any one of supplementals 1 to 3, further comprising:
a main scanning drive unit that moves the inkjet head in a main scanning direction;
a conveyance unit that conveys the printing medium in a sub-scanning direction orthogonally crossing the main scanning direction; and
a control unit that controls the inkjet head, the main scanning drive unit and the conveyance unit to perform printing through a multi-pass method by alternating between an operation of jetting ink to the printing medium from the inkjet head while moving the inkjet head by a printing width in the main scanning direction and an operation of conveying the printing medium in the sub-scanning direction,
wherein the control unit sets printing conditions according to the printing width.

### (Supplemental 5)

The inkjet printing device according to supplemental 3, wherein the control unit sets the printing conditions further according to one or both of a printing medium type and a printing resolution.

### (Supplemental 6)

The inkjet printing device according to supplemental 3 or 4, wherein the printing conditions include at least one condition selected from the group consisting of an amount of ink droplets jetted by the inkjet head, a correspondence relationship between input and output values of image data to be printed, and a maximum amount of ink jetted by the inkjet head per unit time.

### (Supplemental 7)

A method for producing printed matter, comprising the steps of:
attaching ink to a non-absorbent or low-absorbent printing medium;
heating the printing medium for drying the ink attached to the printing medium; and blowing air onto the printing medium for drying the ink attached to the printing medium,
wherein
the ink contains water and an organic solvent S,
an amount of the water is 3.0 to 10.0% by mass with respect to a total amount of the ink,
the organic solvent S includes an organic solvent A with a boiling point of 150° C. or higher and lower than 200° C.,
the printing medium is heated so that a surface temperature of the printing medium is 40 to 43° C. in the step of heating the printing medium, and air is blown at an air velocity of 0.2 to 1.5 m/sec onto the printing medium in the step of blowing air onto the printing medium.

### EXAMPLES

The present disclosure will be described in more detail by way of Examples. The present disclosure is not limited to Examples below.

### Examples of First Embodiment

### <Production of Pigment Dispersion>

Each material shown in Table 1 was measured and put into a beaker at the ratio shown in Table 1, they were premixed, and then transferred to a plastic container with a lid. Zirconia beads with a diameter of 0.8 mm were added thereto, and a dispersion treatment was performed for 60 minutes using a rocking mill RM-05 (manufactured by Seiwa Giken Co., Ltd.). Thereafter, the beads were separated from the obtained dispersion liquid to produce pigment dispersions 1 to 4 all having a pigment concentration of 20% by mass.

The details of the materials shown in Table 1 will be described later.

TABLE 1

| | | Pigment | Pigment | Pigment | Pigment |
|---|---|---|---|---|---|
| Unit: mass % | | dispersion 1 | dispersion 2 | dispersion 3 | dispersion 4 |
| Pigment 1 | | 20.0 | | | |
| Pigment 2 | | | 20.0 | | |
| Pigment 3 | | | | 20.0 | |
| Pigment 4 | | | | | 20.0 |
| Pigment dispersant | Polymeric | 10.0 | 10.0 | 10.0 | 10.0 |
| | dispersant | | | | |
| Organic solvent | Water-soluble | 70.0 | 70.0 | 70.0 | 70.0 |
| | organic solvent | | | | |

| | | | | |
|---|---|---|---|---|
| Total (mass %) | 100.0 | 100.0 | 100.0 | 100.0 |

### <Synthesis of Binder Resin>

A binder resin was produced as follows. In the following, the weight average molecular weight of the produced binder resin is a value obtained by standard polystyrene conversion according to the GPC method. A GPC System manufactured by SHIMADZU CORPORATION was used to perform the measurement. Further, the glass transition temperature (Tg) was calculated using the FOX equation.

### (Synthesis of Binder Resin)

The following was added dropwise over two hours to 317.8 g of diethylene glycol diethyl ether (manufactured by Tokyo Chemical Industry Co., Ltd. (TCI)) kept at 90° C. in a flask with a capacity of 1 L: a mixture obtained by dissolving 340.0 g of methyl methacrylate as a radical polymerizable monomer, and 5.1 g of 2,2′-azobis(isobutyronitrile) (AIBN) (manufactured by Tokyo Chemical Industry Co., Ltd. (TCI)) as a polymerization initiator, in 85.0 g of diethylene glycol diethyl ether. Following completion of the dropwise addition, 1.1 g of AIBN was added thereto after 30 minutes, and also after one hour, while keeping the liquid temperature at 90° C. Further, the mixture was reacted at 90° C. for one hour and diluted with diethylene glycol diethyl ether such that the concentration of active ingredients of the binder resin became 40.0% by mass to obtain a solution of the binder resin. In the solution of the obtained binder resin, the concentration of active ingredients was 40% by mass. The binder resin had a Tg of 105° C., and a weight average molecular weight of 20,000.

### <Production of Ink>

Each material shown in Table 2 was weighed at the ratio shown in Table 2 and mixed and stirred using a three-one motor, and then the mixture was filtered through a membrane filter with a pore size of 3 μm to obtain black ink, cyan ink, magenta ink and yellow ink.

The details of raw materials shown in Table 2 will be described later.

Table 2 shows the amount of the water in the ink, the amount of the organic solvent S in the ink, the amount of the organic solvent A with a boiling point of 150° C. or higher and lower than 200° C. in the ink, the amount of the water-soluble organic solvent B with a boiling point of 150° C. or higher and lower than 200° C. in the ink. Each amount is expressed as a percentage (% by mass) with respect to the total amount of the ink. Table 2 also shows the amount of a water-soluble organic solvent Bx in the water-soluble organic solvent B, which has an HSP value of 25.0 MPa^{1/2} or less and a boiling point of 150° C. or higher and lower than 200° C. The amount is expressed as a percentage (% by mass) with respect to the total amount of the water-soluble organic solvent B.

The amount of the water in the ink shown in Table 2 is a value obtained through measurement by means of the Karl Fischer method. To perform the measurement, as a moisture meter, a Compact Karl Fischer Moisture Meter KF-31 manufactured by Nittoseiko Analytech Co., Ltd. was used.

TABLE 2

| | | | | Magenta | |
|---|---|---|---|---|---|
| Unit: mass % | | Black ink | Cyan ink | ink | Yellow ink |
| Pigment dispersion | Pigment dispersion 1 | 25.0 | | | |
| | Pigment dispersion 2 | | 25.0 | | |
| | Pigment dispersion 3 | | | 25.0 | |
| | Pigment dispersion 4 | | | | 25.0 |
| Water | | 6.0 | 6.0 | 6.0 | 6.0 |
| Binder resin | Solution of binder resin | 20.0 | 20.0 | 20.0 | 20.0 |
| Organic solvent | Water-soluble organic | 48.7 | 48.7 | 48.7 | 48.7 |
| | solvent | | | | |

| | | | | |
|---|---|---|---|---|
| Surfactant | 0.3 | 0.3 | 0.3 | 0.3 |
| Total (mass %) | 100.0 | 100.0 | 100.0 | 100.0 |
| Amount of water in ink (mass %) | 6.7 | 6.7 | 6.7 | 6.7 |
| Amount of organic solvent S in ink (mass %) | 77.5 | 77.5 | 77.5 | 77.5 |
| Amount of organic solvent A in ink (mass %) | 77.5 | 77.5 | 77.5 | 77.5 |
| Amount of water-soluble organic solvent B in ink | 77.5 | 77.5 | 77.5 | 77.5 |
| (mass %) | | | | |
| Amount of water-soluble organic solvent Bx in | 100.0 | 100.0 | 100.0 | 100.0 |
| water-soluble organic solvent B (mass %) | | | | |

The details of materials shown in Tables 1 and 2 are described below.

### (Pigments)

Pigment 1: Carbon black, “MOGUL L” (product name), manufactured by Cabot Corporation
Pigment 2: Copper phthalocyanine, “Fastogen Blue LAS5380” (product name), manufactured by DIC Corporation
Pigment 3: Magenta pigment, “Fastogen Super Magenta JM02” (product name), manufactured by DIC Corporation
Pigment 4: Yellow pigment, “Bayscript Yellow 4GF” (product name), manufactured by LANXESS K.K.

### (Pigment Dispersant)

Polymeric dispersant: “Solsperse J180” (product name), manufactured by The Lubrizol Corporation, active ingredient: 100% by mass

### (Pigment Dispersion)

Pigment dispersions 1 to 4: Produced as above, pigment: 20% by mass, solvent (diethylene glycol diethyl ether): 70% by mass

### (Binder Resin)

Solution of binder resin: Produced as above, active ingredient ((meth)acrylic resin): 40% by mass, solvent (diethylene glycol diethyl ether): 60% by mass, resin Tg: 105° C., resin weight average molecular weight: 20,000

### (Organic Solvent)

Water-soluble organic solvent: Diethylene glycol diethyl ether, manufactured by Tokyo Chemical Industry Co., Ltd. (TCI), boiling point: 188° C., HSP value: 17.5 MPa^{1/2}

### (Surfactant)

Surfactant: Silicone-based surfactant, “BYK-333” (product name), manufactured by BYK-Chemie Japan K.K.

### <Production of Printed Matter>

Using the black ink, cyan ink, magenta ink and yellow ink produced as described above, pieces of printed matter of Examples 1 to 4 and Comparative Examples 1 to 6 were produced as follows.

Using a roll-type inkjet printer (“Perseus DP-194E” (product name) manufactured by DGI), an image was formed on a printing medium by heating the printing medium with a heater and blowing air onto the printing medium with a fan in an environment of 23° C. and 50% RH.

As the printing medium, polypropylene synthetic paper with a whiteness of 96% (“YUPO High-Gloss GAR 110” (product name) manufactured by YUPO Corporation) was used.

As the image, unicolor density gradation patterns of solid black (K), cyan (C), magenta (M) and yellow (Y), each of which includes coverages of 10% to 100% at intervals of 10%, were formed. The printing resolution was 720×2,400 dpi (dot density at a coverage of 100%). The image had a width of 500 mm, and was printed at a productivity of 1.5 m²/h.

The surface temperature of the printing medium, the air velocity and the air temperature in each of Examples 1 to 4 and Comparative Examples 1 to 6 are shown in Table 3.

The surface temperature of the printing medium was measured using a radiation thermometer (“73010” manufactured by Shinwa Rules Co., Ltd.).

The air velocity and the air temperature were measured using an air velocity and temperature meter (“Climomaster Anemometer Model 6501-A0”, Probe “6541” manufactured by KANOMAX JAPAN INC.). The air velocity and the air temperature were measured at a distance from the inkjet head where the air from the fan was most likely to be blown onto the printing medium on the downstream side in the conveyance direction. The air velocity and the air temperature were measured at five points that were evenly spaced along the width of the printing medium. For each of the air speed and the air temperature, an average value of the measurements at the five points was adopted.

### <Evaluation>

For the pieces of printed matter produced as described above, evaluation was performed as follows.

### (Image Sharpness)

The images in the pieces of printed matter of Examples 1 to 4 and Comparative Examples 1 to 6 were visually observed, and the sharpness of the images was evaluated in accordance with the evaluation criteria described below.
◯: All of regions having respective colors and respective coverages are free of bleeding, a blur or a mist stain, and have clear print.
x: There is at least one of bleeding, a blur and a mist stain in at least one of regions having respective colors and respective coverages.

The evaluation results are shown in Table 3.

### (Image Density)

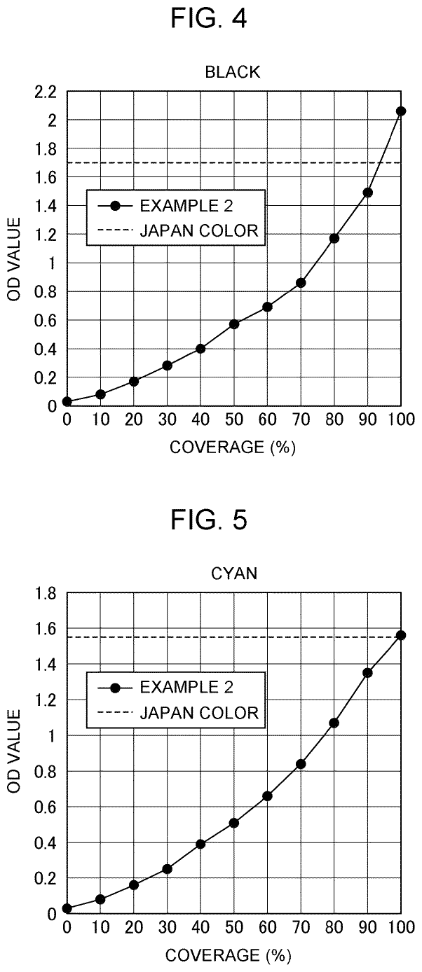

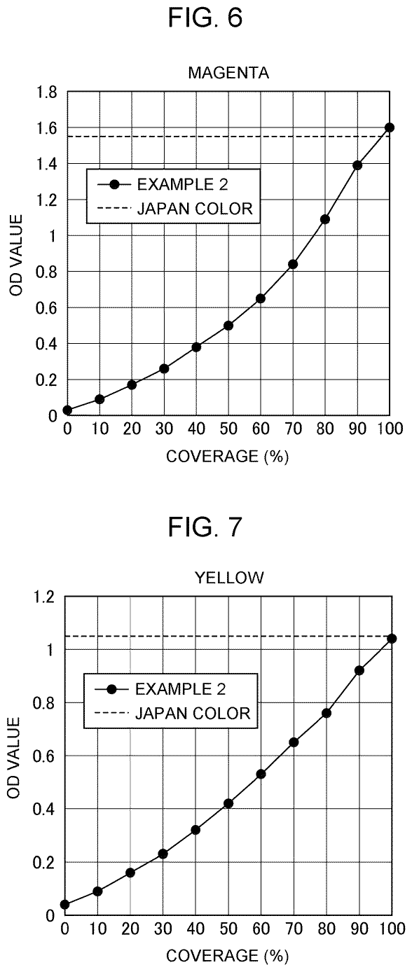

The OD value of each region for each coverage of each of images having respective colors in the piece of printed matter of Example 2 (including a blank sheet) was measured using a spectrophotometric colorimeter (“i1 pro” manufactured by X-Rite, Inc.). The results of measuring the OD values of the images of black, cyan, magenta and yellow are shown in FIGS. 4 to 7, respectively. Here, in FIGS. 4 to 7, the target density (OD value) of Japan Color is indicated by a dashed line. The target density of Japan Color is 1.70 for black, 1.55 for magenta and cyan, and 1.05 for yellow. The measurement conditions are UV cut filter: none, light source: D50, viewing angle: 2 degrees, and density status: T.

TABLE 3

| | Surface | | Air | |
|---|---|---|---|---|
| | temperature of | Air | temper- | Image |
| | printing medium | velocity | ature | sharp- |
| | (° C.) | (m/sec) | (° C.) | ness |
| Example 1 | 40 | 0.2 | 35 | ∘ |
| Example 2 | 43 | 1.5 | 35 | ∘ |
| Example 3 | 40 | 1.5 | 35 | ∘ |
| Example 4 | 43 | 0.2 | 35 | ∘ |
| Comparative Example 1 | 39 | 0.2 | 35 | x |
| Comparative Example 2 | 44 | 0.2 | 35 | x |
| Comparative Example 3 | 43 | 0.1 | 35 | x |
| Comparative Example 4 | 40 | 1.6 | 35 | x |
| Comparative Example 5 | 39 | 1.5 | 34 | x |
| Comparative Example 6 | 44 | 1.5 | 41 | x |

As shown in Table 3, good results were obtained in the evaluation of image sharpness for Examples 1 to 4 in which the surface temperature of the printing medium is 40 to 43° C., the air velocity of air blown onto the printing medium is 0.2 to 1.5 m/sec, and the air temperature is 35 to 40° C.

That is, in Examples 1 to 4, high quality was obtained while printing was performed at a high productivity of 1.5 m²/h with a width of 500 mm.

As shown in FIGS. 4 to 7, in Example 2, the region having a coverage of 100% reached the target density with all inks of respective colors, and a sufficient density was obtained.

On the other hand, in Comparative Examples 1 to 6, good results were not obtained in the evaluation of image sharpness.

In Comparative Examples 1, 3 and 5, bleeding of the image occurred. It is considered that for Comparative Example 1, the surface temperature of the printing medium was lower than 40° C., and for Comparative Example 3, the air velocity was less than 0.2 m/sec, which caused the ink to dry not sufficiently, so that bleeding of the image occurred. It is considered that for Comparative Example 5, the air temperature was lower than 35° C., which caused the printing medium to have a surface temperature of lower than 40° C., so that ink did not sufficiently dry and bleeding of the image occurred.

In Comparative Examples 2 and 6, there was a blur on the image. It is considered that for Comparative Example 2, the surface temperature of the printing medium was higher than 43° C., which caused nozzle clogging and ink adhesion near a nozzle, so that there was a blur on the image due to poor jetting of ink. It is considered that for Comparative Example 6, the air temperature was higher than 40° C., which caused the printing medium to have a surface temperature of higher than 43° C., so that there was a blur on the image due to poor jetting of ink caused by nozzle clogging and ink adhesion near a nozzle.

In Comparative Example 4, a mist stain was generated. It is considered that for Comparative Example 4, the air velocity was more than 1.5 m/sec, which caused ink mist to grow, so that a mist stain was generated.

### Examples of Second Embodiment

### <Production of Printed Matter>

Using the black ink, cyan ink, magenta ink and yellow ink produced in the same manner as in Examples of the first embodiment described above, pieces of printed matter of Examples 5 to 8 and Comparative Examples 7 and 8 were produced as follows.

Using a roll-type inkjet printer (“Perseus DP-194E” (product name) manufactured by DGI), an image was formed on a printing medium by heating the printing medium with a heater and blowing air onto the printing medium with a fan in an environment of 23° C. and 50% RH.

The surface temperature of the printing medium was 42° C. The surface temperature of the printing medium was measured using a radiation thermometer (“73010” manufactured by Shinwa Rules Co., Ltd.).

The air velocity of air blown onto the printing medium was 0.5 m/sec, and the air temperature was 38° C. The air velocity and the air temperature were measured using an air velocity and temperature meter (“Climomaster Anemometer Model 6501-A0”, Probe “6541” manufactured by KANOMAX JAPAN INC.). The air velocity and the air temperature were measured at a distance from the inkjet head where the air from the fan was most likely to be blown onto the printing medium on the downstream side in the conveyance direction. The air velocity and the air temperature were measured at five points that were evenly spaced along the width of the printing medium. For each of the air speed and the air temperature, an average value of the measurements at the five points was adopted.

As the printing medium, polypropylene synthetic paper with a whiteness of 96% (“YUPO High-Gloss GAR 110” (product name) manufactured by YUPO Corporation) was used.

As the image, solid images including solid portions having the colors of black (K), cyan (C), magenta (M), yellow (Y), red (R), green (G) and blue (B) were formed. The image included open lines and characters. The printing resolution was 720×2400 dpi.

The printing width, the amount of ink droplets, the correspondence relationship between input and output values of image data, and the maximum ink amount in each of Examples 5 to 8 and Comparative Examples 7 and 8 are shown in Table 4.

In Table 4, “STD” indicates conditions which yielded good image quality with a test printing width. Here, the printing width of 500 mm (Example 5) is the test printing width.

In Table 4, “10% up” in the correspondence relationship between input and output values of image data indicates that the output value was made larger by 10% than that in the STD conditions. Similarly, “15% down” indicates that the output value was made smaller by 15% than that in the STD conditions.

In Table 4, “20% up” in the maximum ink amount indicates that the maximum ink amount was made larger by 20% than that in the STD conditions. Similarly, “10% down” indicates that the maximum ink amount was made smaller by 10% than that in the STD conditions.

### <Evaluation>

The images in the pieces of printed matter of Examples 5 to 8 and Comparative Examples 7 and 8 were visually observed, and their image quality was evaluated in accordance with the evaluation criteria described below.
◯: There is no decrease in image density or bleeding, and open lines and characters are not collapsed, and can be clearly seen.
Δ: There is at least one of a decrease in image density, bleeding, and collapse of open lines and characters.

The evaluation results are shown in Table 4.

TABLE 4

| | | | Correspondence | | |
|---|---|---|---|---|---|
| | Print- | Amount | relationship | | |
| | ing | of ink | between input and | Maximum | |
| | width | droplets | output values of | ink | Image |
| | (mm) | (pl) | image data | amount | quality |
| Example 5 | 500 | 4 | STD | STD | ◯ |
| Example 6 | 1000 | 6 | STD | STD | ◯ |
| Example 7 | 1500 | 6 | 10% Up | 20% Up | ◯ |
| Example 8 | 100 | 4 | 15% Down | 10% Down | ◯ |
| Comparative | 1500 | 4 | STD | STD | Δ |
| Example 7 | | | | | |
| Comparative | 100 | 4 | STD | STD | Δ |
| Example 8 | | | | | |

Example 5 is an example in which good image quality was obtained in test printing with a printing width of 500 mm.

In Example 6, the printing width was increased from that in Example 5 to 1,000 mm, while the amount of ink droplets was increased from 4 pl in Example 5 to 6 pl, thereby obtaining good image quality.

In Example 7, the printing width was further increased from that in Example 6 to 1,500 mm, while the amount of ink droplets was increased from 4 pl in Example 5 to 6 pl as in Example 6. In Example 7, the correspondence relationship between the input and output values was changed so that the output value of image data was larger by 10% than that in Example 5, and the maximum ink amount was made larger by 20% than that in Example 5. As a result, good image quality was obtained in Example 7.

In Example 8, the printing width was decreased from that in Example 5 to 100 mm, while the correspondence relationship between the input and output values was changed so that the output value of image data was smaller by 15% than that in Example 5, and the maximum ink amount was made smaller by 10% than that in Example 5. As a result, good image quality was obtained in Example 8.

In Comparative Example 7, printing was performed under the same printing conditions as in Example 5, with a printing width of 1,500 mm, which is larger than that in Example 5. In Comparative Example 7, the image density decreased. It is considered that since the printing width was increased while the printing conditions were the same as in Example 5, the amount of ink applied to the printing region per unit time decreased, so that it was impossible to sufficiently fill the solid image with dots, leading to a decrease in density.

In Comparative Example 8, printing was performed under the same printing conditions as in Example 5, with a printing width of 100 mm, which is smaller than that in Example 5. In Comparative Example 8, bleeding of the image, and collapse of open lines and characters occurred. It is considered that since the printing width was decreased while the printing conditions were the same as in Example 5, the amount of ink applied to the printing region per unit time increased, so that bleeding of the image, and collapse of open lines and characters occurred.

The images in the pieces of printed matter of Examples 5 to 8 and Comparative Examples 7 and 8 were evaluated in accordance with the image sharpness evaluation criteria shown in Examples of the first embodiment, and were all rated “O”. In Examples 5 to 8 and Comparative Examples 7 and 8, good results were obtained in the evaluation of image sharpness because the requirement that the surface temperature of the printing medium be 40 to 43° C., the air velocity of air blown onto the printing medium be 0.2 to 1.5 m/sec, and the air temperature be 35 to 40° C. was met as in Examples 1 to 4 of the first embodiment.

That is, while good printing results were obtained in Comparative Examples 7 and 8 under the same printing conditions as in Example 5, better printing results were obtained by changing the printing conditions from those in Example 5 according to a printing width as in Examples 6 to 8.

It is to be noted that, besides those already mentioned above, many modifications and variations of the above embodiments may be made without departing from the novel and advantageous features of the present invention. Accordingly, all such modifications and variations are intended to be included within the scope of the appended claims.

1. An inkjet printing device comprising:
an inkjet head that jets ink to attach the ink to a non-absorbent or low-absorbent printing medium;
a heating unit that heats the printing medium for drying the ink attached to the printing medium; and
an air sending unit that blows air onto the printing medium for drying the ink attached to the printing medium,
wherein
the ink contains water and an organic solvent S,
an amount of the water is 3.0 to 10.0% by mass with respect to a total amount of the ink,
the organic solvent S includes an organic solvent A with a boiling point of 150° C. or higher and lower than 200° C.,
the heating unit heats the printing medium so that a surface temperature of the printing medium is 40 to 43° C., and
the air sending unit blows air at an air velocity of 0.2 to 1.5 m/sec onto the printing medium.

2. The inkjet printing device according to claim 1, wherein the air sending unit blows air at an air temperature of 35 to 40° C. onto the printing medium in an environment of 23° C. and 50% RH.

3. The inkjet printing device according to claim 1, wherein the organic solvent A with a boiling point of 150° C. or higher and lower than 200° C. includes a water-soluble organic solvent B with a boiling point of 150° C. or higher and lower than 200° C.

4. The inkjet printing device according to claim 1, further comprising:
a main scanning drive unit that moves the inkjet head in a main scanning direction;
a conveyance unit that conveys the printing medium in a sub-scanning direction orthogonally crossing the main scanning direction; and
a control unit that controls the inkjet head, the main scanning drive unit and the conveyance unit to perform printing through a multi-pass method by alternating between an operation of jetting ink to the printing medium from the inkjet head while moving the inkjet head by a printing width in the main scanning direction and an operation of conveying the printing medium in the sub-scanning direction,
wherein the control unit sets printing conditions according to the printing width.

5. The inkjet printing device according to claim 4, wherein the control unit sets the printing conditions further according to one or both of a printing medium type and a printing resolution.

6. The inkjet printing device according to claim 5, wherein the printing conditions include at least one condition selected from the group consisting of an amount of ink droplets jetted by the inkjet head, a correspondence relationship between input and output values of image data to be printed, and a maximum amount of ink jetted by the inkjet head per unit area.

7. The inkjet printing device according to claim 2, further comprising:
a main scanning drive unit that moves the inkjet head in a main scanning direction;
a conveyance unit that conveys the printing medium in a sub-scanning direction orthogonally crossing the main scanning direction; and
a control unit that controls the inkjet head, the main scanning drive unit and the conveyance unit to perform printing through a multi-pass method by alternating between an operation of jetting ink to the printing medium from the inkjet head while moving the inkjet head by a printing width in the main scanning direction and an operation of conveying the printing medium in the sub-scanning direction,
wherein the control unit sets printing conditions according to the printing width.

8. The inkjet printing device according to claim 7, wherein the control unit sets the printing conditions further according to one or both of a printing medium type and a printing resolution.

9. The inkjet printing device according to claim 8, wherein the printing conditions include at least one condition selected from the group consisting of an amount of ink droplets jetted by the inkjet head, a correspondence relationship between input and output values of image data to be printed, and a maximum amount of ink jetted by the inkjet head per unit area.

10. A method for producing printed matter, comprising the steps of:
attaching ink to a non-absorbent or low-absorbent printing medium;
heating the printing medium for drying the ink attached to the printing medium; and
blowing air onto the printing medium for drying the ink attached to the printing medium,
wherein
the ink contains water and an organic solvent S,
an amount of the water is 3.0 to 10.0% by mass with respect to a total amount of the ink,
the organic solvent S includes an organic solvent A with a boiling point of 150° C. or higher and lower than 200° C.,
the printing medium is heated so that a surface temperature of the printing medium is 40 to 43° C. in the step of heating the printing medium, and
air is blown at an air velocity of 0.2 to 1.5 m/sec onto the printing medium in the step of blowing air onto the printing medium.
